(19) United States
(12) Patent Application Publication
(10) Pub. No.: US 2026/0161902 A1
(43) Pub. Date: Jun. 11, 2026

(54) METHOD FOR TRANSLATING DOCUMENT AND RELATED DEVICE

(71) Applicant: Beijing Zitiao Network Technology Co., Ltd., Beijing (CN)

(72) Inventors: Chongsheng WANG, Beijing (CN); Jiaxin LIU, Beijing (CN)

(21) Appl. No.: 19/178,725

(22) Filed: Apr. 14, 2025

(30) Foreign Application Priority Data
Apr. 26, 2024 (CN) 202410520210.7

(51) Int. Cl. G06F 40/58; G06F 3/0482; G06F 3/0483; G06F 40/166

(52) U.S. Cl. CPC G06F 40/58; G06F 3/0483; G06F 40/166; G06F 3/0482

(57) ABSTRACT

The present disclosure provides a method for translating a document and a related device. The method includes: in response to a translation instruction for the document, generating a translation of the document, where the document includes an original text; in response to an insertion instruction for the translation, displaying the original text and the translation in the document; and receiving an edit operation on the original text, and updating a translation corresponding to an edited original text based on the edited original text.

### CROSS-REFERENCE TO RELATED APPLICATIONS

The present application is based on and claims priority to China Patent Application No. 202410520210.7 filed on Apr. 26, 2024, the disclosure of which is incorporated by reference herein in its entirety.

### TECHNICAL FIELD

The present disclosure relates to a method for translating a document and a related device.

### BACKGROUND

With the continuous development of Internet technologies, many tasks can be completed in an intelligent manner. For example, some documents can be directly translated from one language to another by means of an online translation tool or function.

### SUMMARY

In a first aspect, the present disclosure provides a method for translating a document, comprising: generating a translation of the document in response to a translation instruction for the document, where the document comprises an original text; displaying the original text and the translation in the document in response to an insertion instruction for the translation; and receiving an edit operation on the original text, and updating a translation corresponding to an edited original text based on the edited original text.

In a second aspect, the present disclosure provides an apparatus for translating a document, comprising: a generation module configured to generate a translation of the document in response to a translation instruction for the document, where the document comprises an original text; an insertion module configured to display the original text and the translation in the document in response to an insertion instruction for the translation; and an update module configured to receive an edit operation on the original text, and update a translation corresponding to an edited original text based on the edited original text.

In a third aspect, the present disclosure provides a computer device, comprising: one or more processors, a memory, and one or more programs, where the one or more programs are stored in the memory and executed by the one or more processors, and the one or more programs comprise instructions for executing the method according to the first aspect.

In a fourth aspect, the present disclosure provides a non-transitory computer-readable storage medium comprising a computer program which, when executed by one or more processors, causes the one or more processors to execute the method according to the first aspect.

In a fifth aspect, the present disclosure provides a computer program product comprising a computer program, where the computer program, when executed by a processor, implements the steps of the method according to the first aspect.

### BRIEF DESCRIPTION OF THE DRAWINGS

In order to more clearly illustrate the technical solutions in the present disclosure or in the related art, the following will briefly introduce the drawings that need to be used in the description of the embodiments or the related art. Obviously, the drawings in the following description are only for the embodiments of the present disclosure, and for those of ordinary skill in the art, other drawings can be obtained according to these drawings without creative efforts.

FIG. 1 shows a schematic diagram of an exemplary system provided by an embodiment of the present disclosure.

FIG. 2A shows a schematic diagram of an exemplary page according to an embodiment of the present disclosure.

FIG. 2B shows another schematic diagram of an exemplary page according to an embodiment of the present disclosure.

FIG. 2C shows another schematic diagram of an exemplary page according to an embodiment of the present disclosure.

FIG. 2D shows another schematic diagram of an exemplary page according to an embodiment of the present disclosure.

FIG. 2E shows another schematic diagram of an exemplary page according to an embodiment of the present disclosure.

FIG. 2F shows another schematic diagram of an exemplary page according to an embodiment of the present disclosure.

FIG. 2G shows another schematic diagram of an exemplary page according to an embodiment of the present disclosure.

FIG. 2H shows another schematic diagram of an exemplary page according to an embodiment of the present disclosure.

FIG. 2I shows another schematic diagram of an exemplary page according to an embodiment of the present disclosure.

FIG. 2J shows another schematic diagram of an exemplary page according to an embodiment of the present disclosure.

FIG. 2K shows another schematic diagram of an exemplary page according to an embodiment of the present disclosure.

FIG. 3 shows a schematic diagram of an exemplary module association relationship according to an embodiment of the present disclosure.

FIG. 4 shows a schematic flowchart of an exemplary method provided by an embodiment of the present disclosure.

FIG. 5 shows a schematic diagram of a hardware structure of an exemplary computer device provided by an embodiment of the present disclosure.

FIG. 6 shows a schematic diagram of an exemplary apparatus provided by an embodiment of the present disclosure.

### DETAILED DESCRIPTION OF EMBODIMENTS

In order to make the objectives, technical solutions and advantages of the present disclosure more clear, the present disclosure will be further described in detail below with reference to the specific embodiments and the drawings.

It should be noted that unless otherwise defined, the technical terms or scientific terms used in the embodiments of the present disclosure should have general meanings as understood by those of ordinary skill in the art to which the present disclosure belongs. “First”, “second” and similar words used in the embodiments of the present disclosure do not indicate any order, quantity or importance, but are only used to distinguish different components. Words such as “include” or “comprise” mean that the element or object in front of the word covers the element or object listed after the word and its equivalents, without excluding other elements or objects. Words such as “connect” or “connected” are not limited to physical or mechanical connection, but can comprise electrical connection, whether direct or indirect. “Up”, “down”, “left”, “right”, etc. are only used to represent the relative positional relationship, and when the absolute position of the described object changes, the relative positional relationship may also change accordingly.

It can be understood that before using the technical solutions of the embodiments of the present disclosure, the user will be informed of the type, scope of use, usage scenarios, etc. of the involved personal information in an appropriate manner, and the user's authorization will be obtained.

For example, in response to receiving an active request from the user, prompt information is sent to the user, so as to clearly inform the user that the operation requested to be performed will require the acquisition and use of the user's personal information. Thus, the user can independently choose whether to provide the personal information to the software or hardware that performs the operations of the technical solutions of the present disclosure, such as an electronic device, an application, a server or a storage medium, according to the prompt information.

As an optional but not limited implementation, the manner of sending the prompt information to the user in response to receiving the active request from the user may be, for example, a pop-up window, and the prompt information may be presented in text in the pop-up window. In addition, the pop-up window may also carry a selection control for the user to choose to “agree” or “disagree” to provide the personal information to the electronic device.

It can be understood that the above process of notifying and acquiring the user's authorization is only illustrative and does not limit the implementations of the present disclosure, and other manners that meet relevant laws and regulations can also be applied to the implementations of the present disclosure.

The inventors of the present disclosure found that in the related art, after the translation is completed, if the original text of the document is modified, the translation cannot be modified adaptively, resulting in the user may miss the update of the translation.

In view of this, an embodiment of the present disclosure provides a method for translating a document.

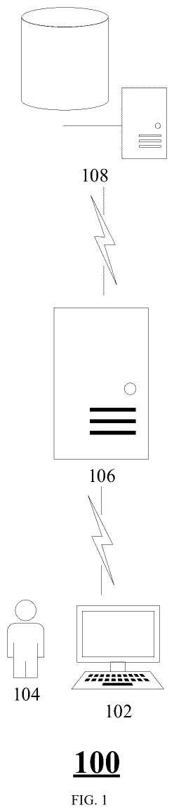

FIG. 1 shows a schematic diagram of an exemplary system 100 provided by an embodiment of the present disclosure.

As shown in FIG. 1, the system 100 can be used to implement an online or offline translation function, and can comprise a terminal device 102, a server 106, and a database server 108. A medium (for example, a network) that provides a communication link may be comprised between the terminal device 102, and the server 106 and the database server 108. The network may comprise various connection types, such as wired, wireless communication links, or fiber optic cables, etc.

Various applications (APPs) can be installed on the terminal device 102, such as a collaborative office application, an image processing application, a video conference application, a reading application, a video application, a social application, a payment application, a web browser, and an instant messaging tool, etc. In some embodiments, these applications can all be used to translate documents.

The terminal device 102 here can be hardware or software. When the terminal device 102 is hardware, it can be various electronic devices with a display screen, comprising but not limited to a smart phone, a tablet computer, an e-book reader, an MP3 player, a laptop computer (Laptop), and a desktop computer (PC), etc. When the terminal device 102 is software, it can be installed in the above-listed electronic devices. It can be implemented as multiple pieces of software or software modules (for example, to provide distributed services), or it can be implemented as a single piece of software or a software module. It is not specifically limited here.

The server 106 can be a server that provides various services, such as a back-end server that supports various applications displayed on the terminal device 102. The database server 108 can also be a database server that provides various services. It can be understood that if the server 106 can implement the related functions of the database server 108, the database server 108 may not be provided in the system 100.

The server 106 and the database server 108 here can also be hardware or software. When they are hardware, they can be implemented as a distributed server cluster composed of multiple servers, or can be implemented as a single server. When they are software, they can be implemented as multiple pieces of software or software modules (for example, to provide distributed services), or can be implemented as a single piece of software or a software module. It is not specifically limited here.

It should be noted that the method for editing a document provided by the embodiments of the present disclosure can be executed by the server 106. It should be understood that the number of terminal devices, users, servers, and database servers in FIG. 1 is only illustrative. According to the needs of the implementation, there can be any number of terminal devices, users, servers, and database servers.

In one embodiment, a collaborative office application or software can be installed on the terminal device 102, and the user 104 can use the application or software installed on the terminal device 102 to perform collaborative office work. For example, editing a document and translating the document from one language to another by means of a translation function.

However, in some scenarios, for example, the user 104 needs to modify the original text of the document, but since the original text has no association relationship with the translation, after the original text changes, the user 104 may not know which part of the translation has been modified, and thus may miss the update of the translation.

In view of this, an aspect of the embodiments of the present disclosure provides a method for translating a document.

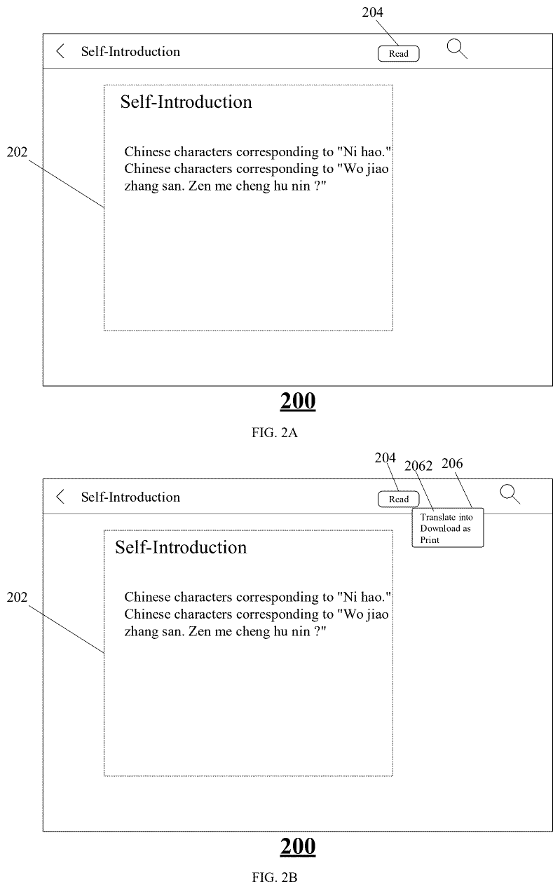

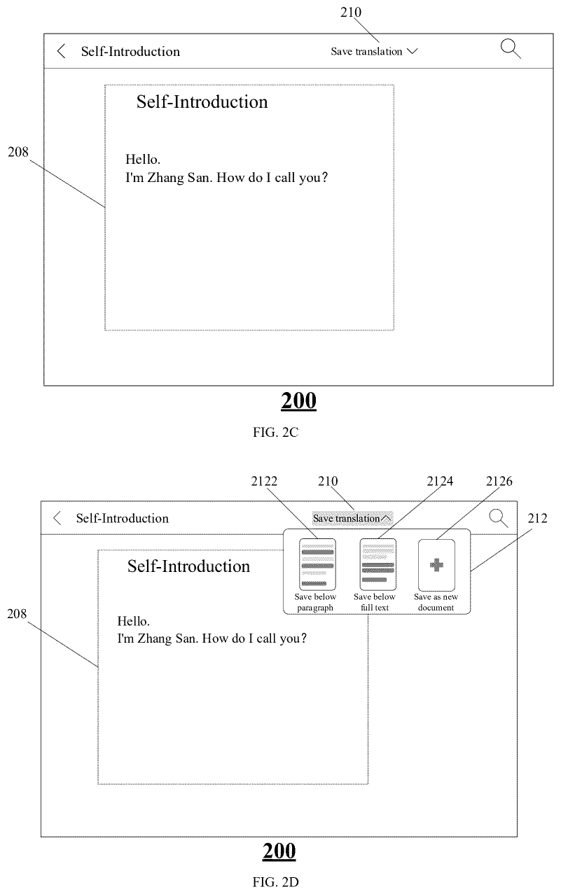

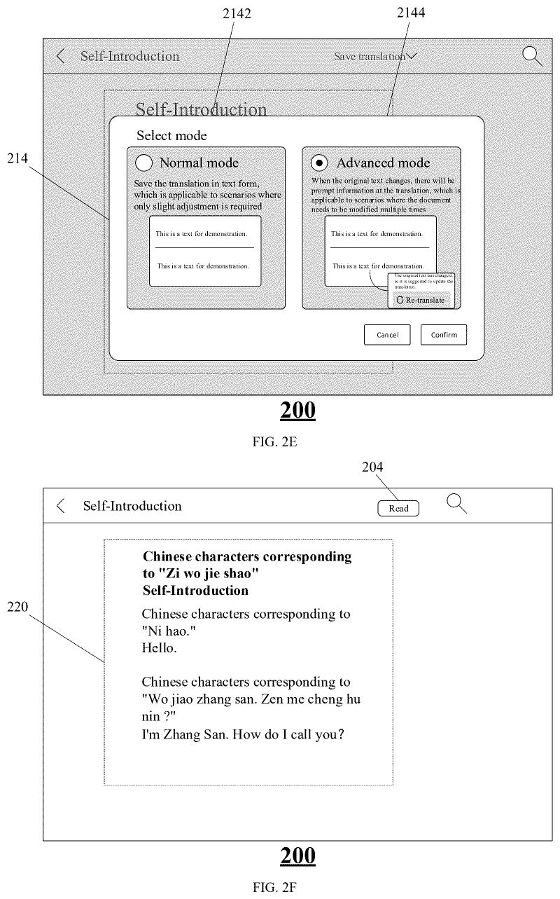

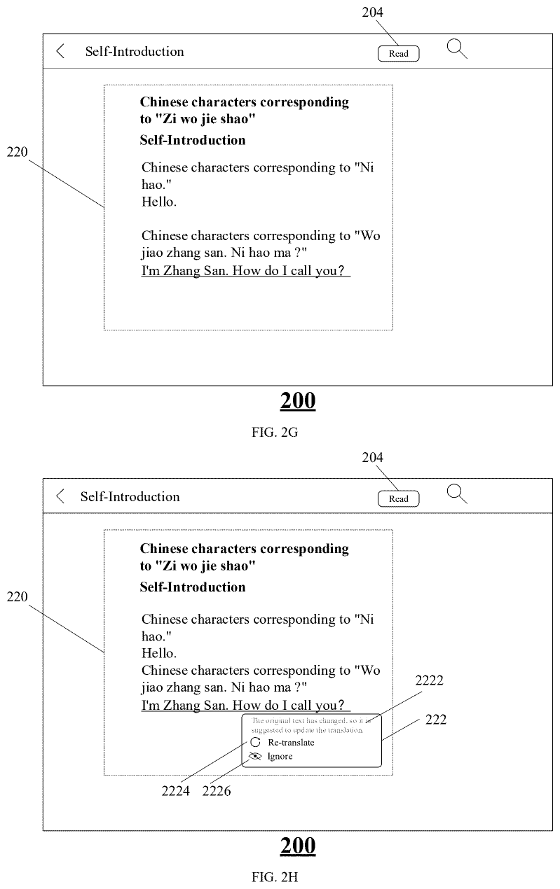

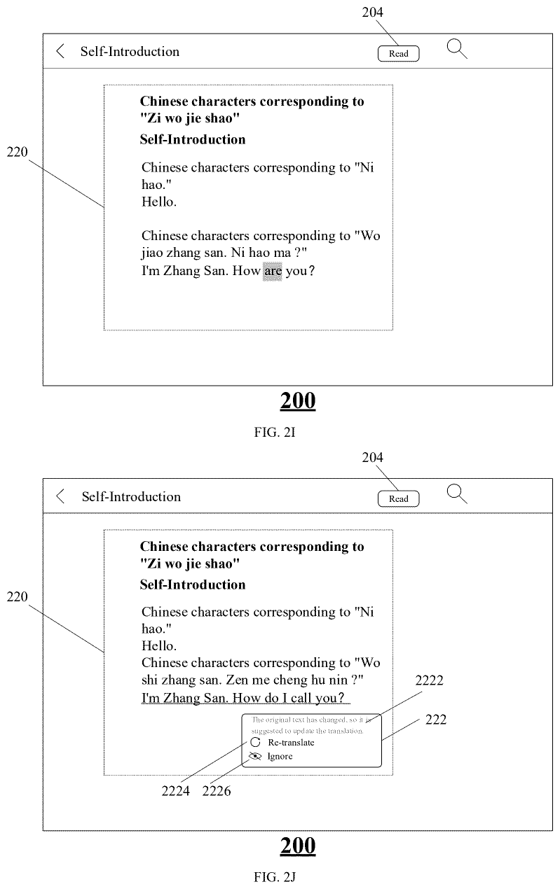

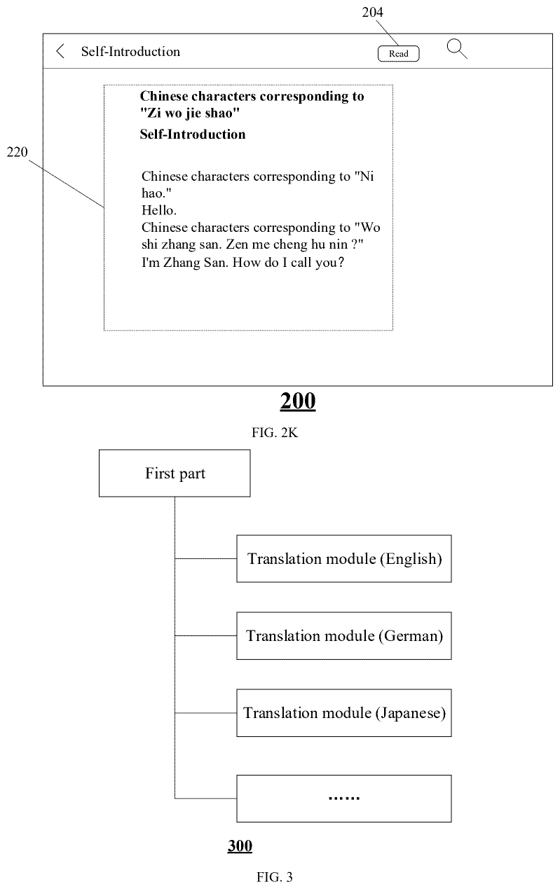

FIG. 2A shows a schematic diagram of an exemplary page 200 according to an embodiment of the present disclosure. The page 200 can be used to display and edit a document.

As shown in FIG. 2A, in some embodiments, the user 104 can use the terminal device 102 to open the collaborative office software, and then the page 200 can be displayed in the terminal device 102. A document 202 can be displayed and edited in the page 202, and the document 202 may further comprise an original text written in a first language (for example, Chinese), which may be content edited by the user 104 in the page 200 or content imported by the user 104.

As shown in FIG. 2A, the page 200 may comprise a control 204, and the control 204 can display a current function state. For example, the control 204 currently displays the word “reading”, indicating that the current state is reading the document 202.

In some embodiments, the user 104 triggers the control 204 (for example, clicks the control 204), and as shown in FIG. 2B, a drop-down menu 206 can be displayed on one side of the control 204, and the drop-down menu 206 can comprise a plurality of controls, each of which corresponds to a different function. Optionally, these controls may comprise a translation control 2062. Optionally, when the user 104 triggers the translation control 2062, the terminal device 102 generates a translation instruction accordingly to generate a translation of the document 202. In some embodiments, the translation generated after the translation control 2062 is triggered may be a default second language (for example, English). In other embodiments, the system can integrate translation modules in a plurality of languages (for example, English, German, Japanese, etc.), and after the translation control 2062 is triggered, a drop-down menu comprising a plurality of sub-translation controls can be further generated on a side of the translation control 2062, and after the user 104 triggers a corresponding sub-translation control, the original text can be translated into a translation in a language corresponding to the sub-translation control. In this way, the user is provided with more language choices, which is convenient to use and improves the user's working efficiency.

FIG. 2C shows another schematic diagram of an exemplary page 200 according to an embodiment of the present disclosure.

As shown in FIG. 2C, after the translation is generated, the translation 208 can be displayed in the page 200, so that the user 104 can check the translation 208, and can modify the content translated automatically to make it more in line with the language expression habit or the author's original intention. In some embodiments, in order to facilitate the user 104 to check the translation 208, the original text and the translation can also be displayed in parallel in the page 200 (for example, the original text is displayed on the left side of the page 200, and the translation is displayed on the right side of the page 200), so that the user 104 can proofread the translation against the original text and the translation.

In some embodiments, as shown in FIG. 2C, the page 200 may comprise a first control 210. Optionally, when the first control 210 is triggered, an insertion instruction of the translation 208 can be generated, so as to insert the translation 208 into the document 202 to generate a document comprising the original text and the translation. Such a document containing the original text and the translation can be viewed by two users who use different languages, which is convenient to use.

In other embodiments, after the first control 210 is triggered, as shown in FIG. 2D, a first window 212 can be displayed on a side of the first control 210, and the first window 212 comprises a plurality of second controls for selecting an insertion mode, such as second controls 2122 and 2124.

As shown in FIG. 2D, exemplary, the insertion mode corresponding to the second control 2122 may be to insert the translation into the original text in units of paragraphs, that is, to insert the translation corresponding to each original text under the original text. The insertion mode corresponding to the second control 2124 may be to insert the translation to the end of the full text of the original text.

In some embodiments, when a target control (for example, the second control 2122 or the second control 2124) of the plurality of second controls is triggered, the translation can be inserted into the document according to an insertion mode corresponding to the target control to generate a document comprising the original text and the translation. In this way, the user 104 can select any insertion mode to generate the document comprising the original text and the translation, so that the layout of the generated document is more in line with the user's habits, and the user experience is improved.

Optionally, as shown in FIG. 2D, the first window 212 may further comprise an archive control 2126. After the archive control 2126 is triggered, the translation 208 can be saved as a new document, so that the user 104 can save the translation 208 separately for subsequent use.

In other embodiments, when the target control of the plurality of second controls is triggered, the insertion is not directly completed, but the second window 214 can be displayed in the page 200 first, as shown in FIG. 2E. Optionally, the second window 214 may further comprise options 2142 and 2144 for setting a function mode of the generated target document.

As shown in FIG. 2E, in some embodiments, the second window 214 may further comprise two options: a normal mode and an advanced mode. When the user selects the normal mode, the translation is only saved in text form after being inserted into the original text. In other words, after the original text is modified, the translation will not be updated, which is more suitable for a scenario where only slight adjustment to the original text is required. When the user selects the advanced mode, the translation is associated with the original text. In other words, after the original text is modified, the translation will be updated accordingly, so that the user can be ensured not to miss the modification of the translation, which is more suitable for a scenario where the document needs to be modified multiple times.

Further, if the user 104 selects the mode option corresponding to the advanced mode (for example, selects the option 2144 and clicks the confirm button), the terminal device 102 can associate the original text with the translation according to the mode option, so that the document is set to the advanced mode, so that when the original text is modified, the translation will be updated accordingly.

In some embodiments, if the user 104 triggers the second control 2122, when the translation 208 is inserted into the document 202, the original text can be divided into a plurality of first parts first, and the translation 208 can be divided into a plurality of second parts according to the plurality of first parts. For example, if the insertion operation is performed in units of paragraphs, the original text can be divided into a plurality of first parts according to the paragraph separators, and the translation 208 can be divided into a plurality of second parts according to the correspondence between the first parts and the translation 208.

Then, the plurality of second parts can be inserted into positions of the original text that correspond to the plurality of first parts.

In some embodiments, in order to determine the corresponding translation after the original text is edited so as to update the translation, an association relationship between the original text and the translation may also be established, and the association relationship is used to enable the translation to correspond to the original text in content, so that when the original text is subsequently modified, the position of the modified part in the translation can be determined according to the association relationship. Optionally, the translation corresponding to the original text in content may be a direct correspondence or an indirect correspondence, where the direct correspondence may be to automatically modify the corresponding translation when the original text is modified, and the indirect correspondence may be to display prompt information at the position of the translation corresponding to the edited original text to indicate that the original text has been edited.

As an optional embodiment, the plurality of second parts may be associated with the plurality of first parts in a one-to-one correspondence to establish the association relationship between the original text and the translation, so that when the original text is subsequently modified, the position of the second part corresponding to the modified first part in the translation can be determined conveniently and quickly according to the association relationship.

In some embodiments, the original text may be divided into a plurality of first parts according to the number of paragraphs of the original text in advance, and a corresponding translation module may be associated with each first part. When there are a plurality of languages that can be translated, each language may correspond to one translation module, and each first part may be associated with translation modules in a plurality of languages.

FIG. 3 shows a schematic diagram of an exemplary module association relationship 300 according to an embodiment of the present disclosure.

As shown in FIG. 3, each first part is associated with a plurality of translation modules corresponding to a plurality of languages. When the user selects to translate the original text in a certain language (for example, English), the translation module of the corresponding language (for example, English) translates the original text of the corresponding first part into a target language (for example, English), and associates the translation part with the corresponding first part. In this way, the translation and association can be realized quickly, and the processing speed is improved.

It can be understood that the first part and the second part are not necessarily divided according to paragraphs, but can also be divided according to sentences or other standards. Here, only the division of paragraphs is taken as an example for description.

FIG. 2F shows another schematic diagram of an exemplary page 200 according to an embodiment of the present disclosure.

As shown in FIG. 2F, after the translation is inserted into the document to generate the document comprising the original text and the translation, the document 220 comprising the original text and the translation may also be displayed in the page 200.

The user 104 can further edit the document 220 in the page 200.

In some scenarios, if the user 104 edits the target content of the original text of the document 220, the terminal device 102 may receive a corresponding edit operation on the original text, and may update the translation corresponding to the edited original text based on the edited original text.

In some embodiments, updating the translation may be generating prompt information indicating that the original text has been edited at a position of the translation that corresponds to the edited original text, so that the user 104 can be reminded, based on the prompt information, that there may be a translation that needs to be revised. Optionally, the reason why the translation is updated by generating prompt information after the original text is edited may be that the association relationship between the original text and the translation is an indirect correspondence. That is, when the indirect correspondence association relationship is established between the original text and the translation, after the original text is edited, the prompt information can be displayed at the corresponding position of the translation, so as to prompt that there may be a translation that needs to be revised, so as to avoid the user from missing the update of the translation.

In some embodiments, when generating the prompt information, the first part corresponding to the edited original text may be determined first, then the second part associated with the first part corresponding to the edited original text may be determined, and then the prompt information is generated at the second part associated with the first part corresponding to the edited original text. In this way, the translation that may need to be modified is determined and the corresponding prompt information is generated based on the association relationship between the first part and the second part. It can be understood that determining the position for generating the prompt information based on the association relationship between the first part and the second part is only exemplary. According to different established relationships, the manner of determining the position of the translation that needs to be modified may be different.

After the prompt information is generated, the prompt information can be output in various ways. For example, the prompt information is displayed at a position of the translation in the page 200 that corresponds to the target content.

FIG. 2G shows another schematic diagram of an exemplary page 200 according to an embodiment of the present disclosure.

As shown in FIG. 2G, exemplary, if the user 104 modifies “How do I call you?” in the original text to “How are you?”, the corresponding translation paragraph “I'm Zhang San. How do I call you?” is added with an underline, which may be a kind of prompt information. In this way, when the user 104 sees that the corresponding translation paragraph is underlined from the page 200, he/she can know that the original text corresponding to the translation paragraph has been modified and that the translation paragraph may contain content that needs to be modified, so that the modification of the translation will not be missed.

It can be seen that in this embodiment, in the original text paragraph “I'm Zhang San. How do I call you?”, only “How do I call you?” is modified to “How are you?”, while “I'm Zhang San.” is not modified, but the corresponding translation paragraph “I'm Zhang San. How do I call you?” is all underlined. This is because, when the first part and the second part are associated in units of paragraphs, when the prompt information is generated, the corresponding paragraph is found in the translation to generate the prompt information. It can be understood that if the first part and the second part are associated in units of sentences or words, when the sentence or word of the original text is modified, the translation may only add prompt information such as an underline to the corresponding sentence or word.

It can be understood that in addition to the underline, other manners may be used to generate the prompt information. For example, a “!” (that is, an exclamation mark pattern) is generated at the position of the translation corresponding to the modified content, so as to prompt the user to pay attention to modifying the translation content of this part. It can also be understood that a plurality of prompt information may be used to jointly prompt the user, for example, adding an underline and displaying an exclamation mark, and so on.

Further, the user 104 may operate on the part of the translation that needs to be modified based on the prompt information.

FIG. 2H shows another schematic diagram of an exemplary page 200 according to an embodiment of the present disclosure.

As shown in FIG. 2H, exemplary, the user 104 may hover the cursor over the prompt information or the translation corresponding to the prompt information, or click the prompt information or the translation corresponding to the prompt information, so as to trigger the display of a third window 222 on a side of the prompt information. As shown in FIG. 2H, the third window 222 may comprise a text prompt 2222 corresponding to the prompt information, for example, “The original text has changed, it is recommended to update the translation”, so that after the user 104 triggers the prompt information, he/she can know that the function of the prompt information is actually to remind the user that the original text corresponding to the translation here has been modified.

In some embodiments, as shown in FIG. 2H, the third window 222 may further comprise a third control 2224 for processing the prompt information. For example, the third control 2224 can be used to re-translate the corresponding translation according to the modified original text. Exemplary, after the user triggers the third control, the target content (the modified content) can be translated into a target translation in the language of the translation (for example, English). In this way, the automatic translation of the modified content can be realized, which is convenient for the user to use and operate, and improves the working efficiency.

In some embodiments, after the re-translation is completed, the original translation corresponding to the target content can be replaced with the target translation, and the target translation can be displayed at the position of the original translation in the page 200.

FIG. 2I shows another schematic diagram of an exemplary page 200 according to an embodiment of the present disclosure.

As shown in FIG. 2I, exemplary, the original translation “How do I call you?” is modified to the target translation “How are you?” corresponding to the target content “How are you?”, and the original translation is replaced with the target translation in the page 200, so as to realize the automatic update of the translation.

In some embodiments, a difference part between the target translation and the original translation may further be determined, and the difference part is highlighted in the target translation, so that the user 104 can know what content of the modified translation has been specifically modified when seeing the highlighted part, and the user experience and working efficiency are improved. As shown in FIG. 2I, the difference between “How do I call you?” and “How are you?” lies in “are”, so “are” can be highlighted alone. It can be understood that if the difference part is in units of sentences, the whole sentence “How are you?” can be highlighted.

In some embodiments, since the user has already performed a corresponding operation on the translation that needs to be modified, as shown in FIG. 2I, the prompt information and the third window 222 may also be hidden, so that the display space of the page 200 can be saved and the reading smoothness of the document can be improved.

FIG. 2J shows another schematic diagram of an exemplary page 200 according to an embodiment of the present disclosure.

As shown in FIG. 2J, exemplary, assuming that “I'm Zhang San” in the original text is modified to “I am Zhang San”, the corresponding translation “I'm Zhang San. How do I call you?” will also be underlined. It can be understood that the translation “I'm Zhang San” can be either “I'm Zhang San” or “I am Zhang San”. Therefore, at this time, the user 104 may not modify the translation, and may trigger a fourth control 2226, so that the prompt information and the third window 222 can be hidden, as shown in FIG. 2K. In this way, after the ignore processing, the user 104 can continue to edit, proofread, and modify the document.

In some embodiments, if the user 104 manually edits the translation corresponding to the target content, it means that the user 104 has already handled the revision of the translation by himself/herself, and the prompt information and the third window 222 may also be hidden.

In other embodiments, updating the translation may be to automatically update the translation directly according to the edited original text. For example, after re-translating the edited original text, replacing the original translation with the re-translated target translation. Referring to FIG. 2G and FIG. 2I, when the user modifies “How do I call you?” to “How are you?”, exemplary, the original translation “How do I call you?” is automatically updated to the target translation “How are you?” corresponding to “How are you?”, and the original translation is replaced with the target translation in the page 200, so as to realize the automatic update of the translation.

Optionally, the reason why the translation is updated by directly re-translating the translation according to the modified original text after the original text is edited may be that the association relationship between the original text and the translation is a direct correspondence. That is, when a direct correspondence association relationship is established between the original text and the translation, after the original text is edited, the corresponding translation can be directly re-translated into a new translation according to the edited original text, so as to avoid the user from missing the update of the translation, and at the same time, the efficiency of the translation update is also improved.

In some embodiments, updating the translation may also be to directly update the translation automatically according to the edited original text and display the prompt information (for example, underline). In this way, on the one hand, the content of the translation is automatically updated, and on the other hand, the prompt information is used to indicate that the translation is updated synchronously, so that the user can know where the translation has been updated, which is convenient for backtracking and proofreading.

It can be seen from the above embodiments that, in the method for translating a document provided by the embodiments of the present disclosure, after the original text changes, the corresponding translation can be updated, which can help the user to update the translation adaptively, so as to avoid missing the update of the translation, and improve the working efficiency. Compared with a mode in the related art where the translation can only be inserted into the original text in text form, the embodiments of the present disclosure can conveniently indicate that the corresponding translation also needs to be modified, so as to avoid the user from missing the update of the translation.

It should be noted that the method of the embodiments of the present disclosure may be executed by a single device, such as a computer or a server. The method of this embodiment may also be applied to a distributed scenario, and multiple devices cooperate with each other to complete the method. In this distributed scenario, one of the multiple devices may only execute one or more steps in the method of the embodiments of the present disclosure, and the multiple devices may interact with each other to complete the method.

It should be noted that some embodiments of the present disclosure are described above. Other embodiments are within the scope of the appended claims. In some cases, the acts or steps recited in the claims may be performed in a different order than in the above embodiments and still achieve the desired results. In addition, the processes depicted in the drawings do not necessarily require the specific order shown or the continuous order to achieve the desired results. In some implementations, multitasking and parallel processing are also possible or may be advantageous.

FIG. 4 shows a schematic flowchart of an exemplary method 400 provided by an embodiment of the present disclosure. The method 400 may be used to edit and translate a document. Optionally, the method 400 may be performed by the terminal device 102 in FIG. 1 alone, or may also be performed by the system 100 in FIG. 1.

As shown in FIG. 4, the method 400 may further comprise the following steps.

In step 402, in response to a translation instruction for the document (for example, the document 202 in FIG. 2A), a translation of the document (for example, the translation 208 in FIG. 2C) is generated, where the document comprises an original text (for example, content written in Chinese, as shown in FIG. 2A).

In step 404, in response to an insertion instruction for the translation, the original text and the translation are displayed in the document (for example, the document 220 in FIG. 2F).

In some embodiments, in order to determine the corresponding translation after the original text is edited so as to update the translation, displaying the original text and the translation in the document comprises: establishing an association relationship between the original text and the translation, where the association relationship is used to enable the translation to correspond to the original text in content. Optionally, the translation corresponding to the original text in content may be a direct correspondence or an indirect correspondence, where the direct correspondence may be to automatically modify the corresponding translation when the original text is modified, and the indirect correspondence may be to display prompt information at the position of the translation corresponding to the edited original text to indicate that the original text has been edited.

In some embodiments, the original text comprises a plurality of first parts, the translation comprises a plurality of second parts, and the plurality of second parts are associated with the plurality of first parts in a one-to-one correspondence, so that when the original text is subsequently modified, the position of the modified part in the translation can be determined according to the association relationship.

As shown in FIG. 3, each first part is associated with a plurality of translation modules corresponding to a plurality of languages. When the user selects to translate the original text in a certain language (for example, English), the translation module of the corresponding language (for example, English) translates the original text of the corresponding first part into a target language (for example, English), thus generating a corresponding second part, and the second part can be associated with the corresponding first part. In this way, the translation and association can be realized quickly, and the processing speed is improved.

It can be understood that the first part and the second part are not necessarily divided according to paragraphs, but can also be divided according to sentences or other standards.

In some embodiments, displaying the original text and the translation in the document comprises: inserting the translation into the document to generate a target document comprising the original text and the translation, comprising: dividing the original text into a plurality of first parts; dividing the translation into a plurality of second parts according to the plurality of first parts; and inserting the plurality of second parts into positions of the original text that correspond to the plurality of first parts.

In this way, the translation is interspersed in the original text, which is convenient for the user to view the original text and the translation in comparison, and improves the working efficiency.

In some embodiments, after generating the translation of the document, the method further comprises: displaying the translation (for example, the translation 208 in FIG. 2C) in a target page (for example, the page 200 in FIG. 2C), so that the user can view and edit the translation.

In some embodiments, after generating the translation of the document, the method further comprises: displaying the original text and the translation in parallel in the target page, so that the user can view and edit the translation against the original text, thereby improving the working efficiency.

In some embodiments, the target page comprises a first control (for example, the first control 210 in FIG. 2C); displaying the original text and the translation in the document in response to the insertion instruction for the translation comprises: in response to a trigger instruction for the first control, displaying a first window (for example, the first window 212 in FIG. 2D) on a side of the first control in the target page, the first window comprising a plurality of second controls (for example, the second controls 2122 and 2124 in FIG. 2D) for selecting an insertion mode; and in response to a trigger instruction for a target control (for example, the second control 2122 or the second control 2124 in FIG. 2D) of the plurality of second controls, displaying the original text and the translation in the document in the target page according to an insertion mode corresponding to the target control.

In this way, the user selects the insertion mode to implement the insertion of the translation, so that the layout of the generated target document is more in line with the user's habits, and the user experience is improved.

In some embodiments, in response to the trigger instruction for the target control of the plurality of second controls, displaying the original text and the translation in the document in the target page according to the insertion mode corresponding to the target control comprises: in response to the trigger instruction for the target control of the plurality of second controls, displaying a second window (for example, the second window 214 in FIG. 2E) in the target page, the second window comprising a mode option (for example, the options 2142 and 2144 in FIG. 2E) for associating the original text with the translation; and in response to an instruction to select the mode option, displaying the original text and the translation in the document in the target page according to the insertion mode corresponding to the target control, and associating the original text with the translation according to the mode option, so that the target document is set to an advanced mode, so that when the original text is modified, prompt information can be displayed at the corresponding position of the translation.

In step 406, an edit operation on the original text is received, and a translation corresponding to the edited original text is updated based on the edited original text.

Optionally, updating the translation may be generating prompt information indicating that the original text has been edited at a position of the translation that corresponds to the edited original text, so that the user 104 can be reminded, based on the prompt information, that there may be a translation that needs to be revised. Optionally, the reason why the translation is updated by generating prompt information after the original text is edited may be that the association relationship between the original text and the translation is an indirect correspondence. That is, when the indirect correspondence association relationship is established between the original text and the translation, after the original text is edited, the prompt information can be displayed at the corresponding position of the translation, so as to prompt that there may be a translation that needs to be revised, so as to avoid the user from missing the update of the translation.

In other embodiments, updating the translation may be to automatically update the translation directly according to the edited original text. For example, after re-translating the edited original text, replacing the original translation with the re-translated target translation. Optionally, the reason why the translation is updated by directly re-translating the translation according to the modified original text after the original text is edited may be that the association relationship between the original text and the translation is a direct correspondence. That is, when a direct correspondence association relationship is established between the original text and the translation, after the original text is edited, the corresponding translation can be directly re-translated into a new translation according to the edited original text, so as to avoid the user from missing the update of the translation, and at the same time, the efficiency of the translation update is also improved.

In some embodiments, updating the translation may also be to directly update the translation automatically according to the edited original text and display the prompt information (for example, underline). In this way, on the one hand, the content of the translation is automatically updated, and on the other hand, the prompt information is used to indicate that the translation is updated synchronously, so that the user can know where the translation has been updated, which is convenient for backtracking and proofreading.

It can be seen from the above embodiments that, in the method for translating a document provided by the embodiments of the present disclosure, after the original text changes, the prompt information can be displayed at the corresponding translation position, so as to prompt the user to update the translation adaptively, so as to avoid missing the update of the translation, and improve the working efficiency.

In some embodiments, updating the translation corresponding to the edited original text based on the edited original text comprises: determining the first part corresponding to the target content; determining the second part associated with the first part corresponding to the target content; and generating the prompt information at the second part associated with the first part corresponding to the target content.

In this way, after the original text changes, the corresponding position of the translation is found according to the association relationship, and the prompt information can be displayed at the corresponding translation position, so as to avoid the user from missing the update of the translation.

In some embodiments, updating the translation corresponding to the edited original text based on the edited original text comprises: displaying the document (for example, the document 220 in FIG. 2F) in a target page, so that it is convenient for the user to view and edit.

In some embodiments, updating the translation corresponding to the edited original text based on the edited original text comprises: displaying, at a position of the translation in the target page that corresponds to the edited original text, prompt information (for example, the underline in FIG. 2G) indicating that the original text has been edited, so as to avoid the user from missing the update of the translation.

In some embodiments, the method further comprises: in response to the prompt information being triggered, displaying a third window (for example, the third window 222 in FIG. 2H) on a side of the prompt information in the target page, the third window comprising a text prompt (for example, the text prompt 2222 in FIG. 2H) corresponding to the prompt information, so that after the user 104 triggers the prompt information, he/she can know that the function of the prompt information is actually to remind the user that the original text corresponding to the translation here has been modified.

In some embodiments, the third window further comprises a third control (for example, the third control 2224 in FIG. 2H) for processing the prompt information; the method further comprises: in response to a trigger instruction for the third control, translating the edited original text into a target translation in the language of the translation; replacing the original translation corresponding to the edited original text with the target translation; and displaying the target translation at a position of the original translation in the target page.

In this way, the automatic translation of the modified content can be realized, which is convenient for the user to use and operate, and improves the working efficiency.

In some embodiments, displaying the target translation at the position of the original translation in the target page comprises: determining a difference part between the target translation and the original translation; and highlighting the difference part in the target translation.

In this way, the user 104 can know what content of the modified translation has been specifically modified when seeing the highlighted part, so that the user experience and working efficiency are improved.

In some embodiments, after displaying the target translation at the position of the original translation in the target page, the method further comprises: hiding the prompt information and the third window, so that the display space of the page 200 can be saved and the reading smoothness of the document can be improved.

In some embodiments, the third window further comprises a fourth control (for example, the fourth control 2226 in FIG. 2J) for processing the prompt information; the method further comprises: in response to a trigger instruction for the fourth control, hiding the prompt information and the third window, so that the display space of the page 200 can be saved and the reading smoothness of the document can be improved.

In some embodiments, the method further comprises: hiding the prompt information and the third window in response to the original translation corresponding to the edited original text being edited, so that the display space of the page 200 can be saved and the reading smoothness of the document can be improved.

It should be noted that the method of the embodiments of the present disclosure may be executed by a single device, such as a computer or a server. The method of this embodiment may also be applied to a distributed scenario, and multiple devices cooperate with each other to complete the method. In this distributed scenario, one of the multiple devices may only execute one or more steps in the method of the embodiments of the present disclosure, and the multiple devices may interact with each other to complete the method.

It should be noted that some embodiments of the present disclosure are described above. Other embodiments are within the scope of the appended claims. In some cases, the acts or steps recited in the claims may be performed in a different order than in the above embodiments and still achieve the desired results. In addition, the processes depicted in the drawings do not necessarily require the specific order shown or the continuous order to achieve the desired results. In some implementations, multitasking and parallel processing are also possible or may be advantageous.

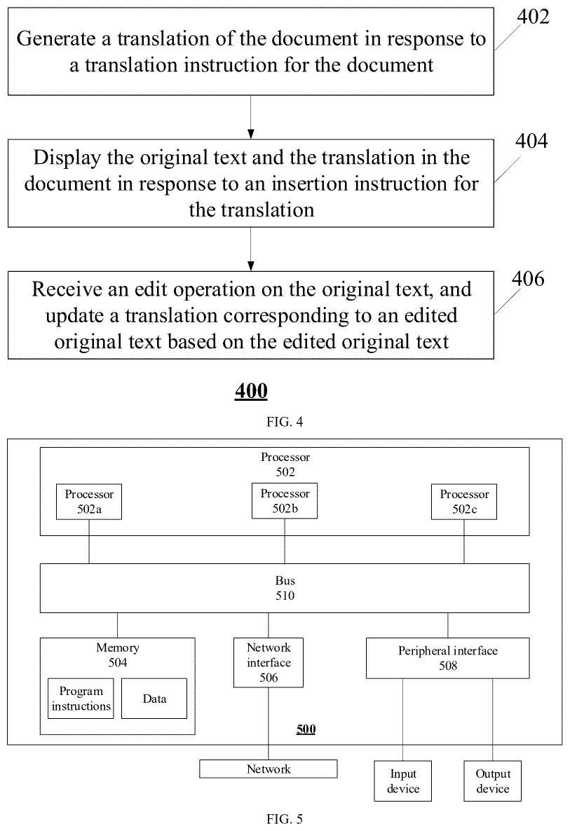

An embodiment of the present disclosure further provides a computer device for implementing the above method 400. FIG. 5 shows a schematic diagram of a hardware structure of an exemplary computer device 500 provided by an embodiment of the present disclosure. The computer device 500 can be used to implement the server 106 in FIG. 1, and can also be used to implement the terminal devices 102 and 104 in FIG. 1. In some scenarios, the computer device 500 can also be used to implement the database server 108 in FIG. 1.

As shown in FIG. 5, the computer device 500 may comprise: a processor 502, a memory 504, a network module 506, a peripheral interface 508, and a bus 510. The processor 502, the memory 504, the network module 506, and the peripheral interface 508 implement communication connection between each other inside the computer device 500 through the bus 510.

The processor 502 may be a central processing unit (Central Processing Unit, CPU), an image processor, a neural network processor (NPU), a microcontroller (MCU), a programmable logic device, a digital signal processor (DSP), an application specific integrated circuit (Application Specific Integrated Circuit, ASIC), or one or more integrated circuits. The processor 502 can be used to perform functions related to the technology described in the present disclosure. In some embodiments, the processor 502 may further comprise multiple processors integrated as a single logical component. For example, as shown in FIG. 5, the processor 502 may comprise multiple processors 502a, 502b, and 502c.

The memory 504 may be configured to store data (for example, instructions, computer code, etc.). As shown in FIG. 5, the data stored in the memory 504 may comprise program instructions (for example, program instructions for implementing the method 400 of the embodiments of the present disclosure) and data to be processed (for example, the memory may store configuration files of other modules, etc.). The processor 502 may also access the program instructions and data stored in the memory 504, and execute the program instructions to operate on the data to be processed. The memory 504 may comprise a volatile storage apparatus or a non-volatile storage apparatus. In some embodiments, the memory 504 may comprise a random access memory (RAM), a read-only memory (ROM), an optical disc, a magnetic disk, a hard disk, a solid-state drive (SSD), a flash memory, a memory stick, etc.

The network interface 506 may be configured to provide communication with other external devices to the computer device 500 via the network. The network may be any wired or wireless network capable of transmitting and receiving data. For example, the network may be a wired network, a local wireless network (for example, Bluetooth, WiFi, near field communication (NFC), etc.), a cellular network, the Internet, or a combination thereof. It can be understood that the type of the network is not limited to the above specific examples.

The peripheral interface 508 may be configured to connect the computer device 500 with one or more peripheral devices to realize information input and output. For example, the peripheral devices may comprise input devices such as a keyboard, a mouse, a touchpad, a touch screen, a microphone, various sensors, and output devices such as a display, a speaker, a vibrator, and an indicator light.

The bus 510 may be configured to transmit information between various components (for example, the processor 502, the memory 504, the network interface 506, and the peripheral interface 508) of the computer device 500, such as an internal bus (for example, a processor-memory bus), an external bus (a USB port, a PCI-E bus), and the like.

It should be noted that although the above architecture of the computer device 500 only shows the processor 502, the memory 504, the network interface 506, the peripheral interface 508, and the bus 510, in the specific implementation process, the architecture of the computer device 500 may also comprise other components necessary for normal operation. In addition, those skilled in the art may understand that the above architecture of the computer device 500 may also comprise only components necessary for implementing the solutions of the embodiments of the present disclosure, and not necessarily all components shown in the figure.

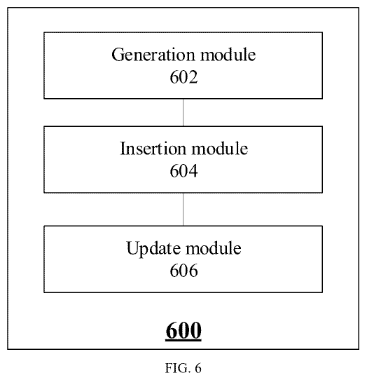

An embodiment of the present disclosure further provides an apparatus for translating a document. FIG. 6 shows a schematic diagram of an exemplary apparatus 600 provided by an embodiment of the present disclosure. As shown in FIG. 6, the apparatus 600 can be used to implement the method 400, and may further comprise the following modules: a generation module 602 configured to generate a translation of the document in response to a translation instruction for the document, where the document comprises an original text; an insertion module 604 configured to display the original text and the translation in the document in response to an insertion instruction for the translation; and an update module 606 configured to receive an edit operation on the original text, and update a translation corresponding to the edited original text based on the edited original text.

In some embodiments, the insertion module 604 is configured to establish an association relationship between the original text and the translation, the association relationship being used to enable the translation to correspond to the original text in content.

In some embodiments, the original text comprises a plurality of first parts, the translation comprises a plurality of second parts, and the plurality of second parts are associated with the plurality of first parts in a one-to-one correspondence.

In some embodiments, the insertion module 604 is configured to: divide the original text into a plurality of first parts; divide the translation into a plurality of second parts according to the plurality of first parts; and insert the plurality of second parts into positions of the original text that correspond to the plurality of first parts.

In some embodiments, the update module 606 is configured to: determine the first part corresponding to the target content; determine the second part associated with the first part corresponding to the target content; and generate the prompt information at the second part associated with the first part corresponding to the target content.

In some embodiments, the generation module 602 is configured to: display the translation in the target page; or, display the original text and the translation in parallel in the target page.

In some embodiments, the target page comprises a first control, and the insertion module 604 is configured to: in response to a trigger instruction for the first control, display a first window on a side of the first control in the target page, the first window comprising a plurality of second controls for selecting an insertion mode; and in response to a trigger instruction for a target control of the plurality of second controls, display the original text and the translation in the document in the target page according to an insertion mode corresponding to the target control.

In some embodiments, the insertion module 604 is configured to: in response to the trigger instruction for the target control of the plurality of second controls, display a second window in the target page, the second window comprising a mode option for associating the original text with the translation; and in response to an instruction to select the mode option, display the original text and the translation in the document in the target page according to the insertion mode corresponding to the target control, and associate the original text with the translation according to the mode option.

In some embodiments, the update module 606 is configured to display, at a position of the translation in the target page that corresponds to the edited original text, prompt information indicating that the original text has been edited.

In some embodiments, the update module 606 is configured to, in response to the prompt information being triggered, display a third window on a side of the prompt information in the target page, the third window comprising a text prompt corresponding to the prompt information.

In some embodiments, the third window further comprises a third control for processing the prompt information; and the update module 606 is configured to: in response to a trigger instruction for the third control, translate the edited original text into a target translation in the language of the translation; replace the original translation corresponding to the edited original text with the target translation; and display the target translation at a position of the original translation in the target page.

In some embodiments, the update module 606 is configured to hide the prompt information and the third window.

In some embodiments, the third window further comprises a fourth control for processing the prompt information; and the update module 606 is configured to, in response to a trigger instruction for the fourth control, hide the prompt information and the third window.

In some embodiments, the update module 606 is configured to: determine a difference part between the target translation and the original translation; and highlight the difference part in the target translation.

In some embodiments, the update module 606 is configured to hide the prompt information and the third window in response to the original translation corresponding to the edited original text being edited.

For the convenience of description, the above apparatus is described as various modules according to functions. Of course, when implementing the present disclosure, the functions of each module can be implemented in the same or multiple pieces of software and/or hardware.

The apparatus of the above embodiment is used to implement the corresponding method 400 in any of the foregoing embodiments, and has the beneficial effects of the corresponding method embodiments, which will not be repeated here.

Based on the same inventive concept, corresponding to the above method of any embodiment, the present disclosure further provides a non-transitory computer-readable storage medium, the non-transitory computer-readable storage medium stores computer instructions, and the computer instructions are used to cause the computer to execute the method 400 according to any of the above embodiments.

The computer-readable medium of this embodiment comprises permanent and non-permanent, removable and non-removable media, and information storage can be implemented by any method or technology. The information may be computer-readable instructions, data structures, program modules, or other data. Examples of computer storage media comprise, but are not limited to, phase change memory (PRAM), static random access memory (SRAM), dynamic random access memory (DRAM), other types of random access memory (RAM), read only memory (ROM), electrically erasable programmable read-only memory (EEPROM), flash memory or other memory technologies, compact disc read-only memory (CD-ROM), digital versatile disc (DVD) or other optical storage, magnetic cassette, tape magnetic disk storage or other magnetic storage devices, or any other non-transmission medium, which can be used to store information that can be accessed by the computing device.

The computer instructions stored in the storage medium of the above embodiment are used to cause the computer to execute the method 400 according to any of the above embodiments, and have the beneficial effects of the corresponding method embodiments, which will not be repeated here.

Based on the same inventive concept, corresponding to the above method 400 of any embodiment, the present disclosure further provides a computer program product comprising a computer program. In some embodiments, the computer program is executable by one or more processors to cause the processor to execute the method 400. Corresponding to the execution subject corresponding to each step in the embodiments of the method 400, the processor that executes the corresponding step may belong to the corresponding execution subject.

In some embodiments, the computer program product comprises a program module for resolving an operation conflict, and the program module comprises a module that is compiled into a binary instruction set (for example, wasm) based on a stack virtual machine and is used to be invoked by a terminal device, and/or a module that is compiled into a static library and is used to be invoked by a server.

The computer program product of the above embodiment is used to cause the processor to execute the method 400 according to any of the above embodiments, and has the beneficial effects of the corresponding method embodiments, which will not be repeated here.

Those of ordinary skill in the art should understand that the discussion of any of the above embodiments is only exemplary, and is not intended to imply that the scope of the present disclosure (comprising the claims) is limited to these examples; under the concept of the present disclosure,, the technical features in the above embodiments or different embodiments may also be combined, the steps may be implemented in any order, and there are many other changes in different aspects of the embodiments of the present disclosure as described above, which are not provided in detail for the sake of brevity.

In addition, in order to simplify the description and discussion, and in order not to make the embodiments of the present disclosure difficult to understand, the well-known power/ground connections of integrated circuit (IC) chips and other components may or may not be shown in the provided drawings. In addition, the apparatus may be shown in the form of a block diagram in order to avoid making the embodiments of the present disclosure difficult to understand, and this also takes into account the fact that the details of the implementations of these block diagram apparatus are highly dependent on the platform on which the embodiments of the present disclosure are to be implemented (that is, these details should be fully within the understanding of those of ordinary skill in the art). In the case where specific details (for example, circuits) are described to describe the exemplary embodiments of the present disclosure, it is obvious to those of ordinary skill in the art that the embodiments of the present disclosure may be implemented without these specific details or with changes in these specific details. Therefore, these descriptions should be considered as illustrative rather than restrictive.

Although the present disclosure has been described in combination with specific embodiments of the present disclosure, many substitutions, modifications, and variations of these embodiments will be apparent to those of ordinary skill in the art from the foregoing description. For example, other memory architectures (for example, dynamic RAM (DRAM)) may use the discussed embodiments.

The embodiments of the present disclosure are intended to cover all such replacements, modifications, and variations that fall within the broad scope of the appended claims. Therefore, any omission, modification, equivalent replacement, improvement, etc. made within the spirit and principles of the embodiments of the present disclosure shall be comprised in the protection scope of the present disclosure.

I/We claim:

1. A method for translating a document, comprising:
generating a translation of the document in response to a translation instruction for the document, wherein the document comprises an original text;
displaying the original text and the translation in the document in response to an insertion instruction for the translation; and
receiving an edit operation on the original text, and updating a translation corresponding to an edited original text based on the edited original text.

2. The method according to claim 1, wherein displaying the original text and the translation in the document comprises:
establishing an association relationship between the original text and the translation, for enabling the translation to correspond to the original text in content.

3. The method according to claim 1, wherein the original text comprises a plurality of first parts, the translation comprises a plurality of second parts, and the plurality of second parts are associated with the plurality of first parts in a one-to-one correspondence.

4. The method according to claim 1, wherein displaying the original text and the translation in the document comprises:
dividing the original text into a plurality of first parts;
dividing the translation into a plurality of second parts according to the plurality of first parts; and
inserting the plurality of second parts into positions of the original text that correspond to the plurality of first parts.

5. The method according to claim 4, wherein updating the translation corresponding to the edited original text based on the edited original text comprises:
determining a first part corresponding to target content;
determining a second part associated with the first part corresponding to the target content; and
generating prompt information at the second part associated with the first part corresponding to the target content.

6. The method according to claim 1, wherein after generating the translation of the document, the method further comprises:
displaying the translation in a target page; or
displaying the original text and the translation in the target page in parallel.

7. The method according to claim 6, wherein the target page comprises a first control; and
displaying the original text and the translation in the document in response to the insertion instruction for the translation comprises:
in response to a trigger instruction for the first control, displaying a first window on a side of the first control in the target page, the first window comprising a plurality of second controls for selecting an insertion mode; and
in response to a trigger instruction for a target control of the plurality of second controls, displaying the original text and the translation in the document in the target page according to an insertion mode corresponding to the target control.

8. The method according to claim 7, wherein in response to the trigger instruction for the target control of the plurality of second controls, displaying the original text and the translation in the document according to the insertion mode corresponding to the target control comprises:
in response to the trigger instruction for the target control of the plurality of second controls, displaying a second window in the target page, the second window comprising a mode option for associating the original text with the translation; and
in response to an instruction to select the mode option, displaying the original text and the translation in the document in the target page according to the insertion mode corresponding to the target control, and associating the original text with the translation according to the mode option.

9. The method according to claim 6, wherein updating the translation corresponding to the edited original text based on the edited original text comprises:
displaying, at a position of the translation in the target page that corresponds to the edited original text, prompt information indicating that the original text has been edited.

10. The method according to claim 9, further comprising:
in response to the prompt information being triggered, displaying a third window on a side of the prompt information in the target page, the third window comprising a text prompt corresponding to the prompt information.

11. The method according to claim 10, wherein the third window further comprises a third control for processing the prompt information; and the method further comprises:
in response to a trigger instruction for the third control, translating the edited original text into a target translation in a language of the translation;
replacing an original translation corresponding to the edited original text with the target translation; and
displaying the target translation at a position of the original translation in the target page.

12. The method according to claim 11, after displaying the target translation at the position of the original translation in the target page, the method further comprises:
hiding the prompt information and the third window.

13. The method according to claim 10, wherein the third window further comprises a fourth control for processing the prompt information; and the method further comprises:
in response to a trigger instruction for the fourth control, hiding the prompt information and the third window.

14. The method according to claim 11, wherein displaying the target translation at the position of the original translation in the target page comprises:
determining a difference part between the target translation and the original translation; and
highlighting the difference part in the target translation.

15. The method according to claim 10, further comprising:
hiding the prompt information and the third window in response to an original translation corresponding to the edited original text being edited.

16. A computer device, comprising: one or more processors, and a memory, wherein one or more programs are stored in the memory and executed by the one or more processors to cause the one or more processors to:
generate a translation of a document in response to a translation instruction for the document, wherein the document comprises an original text;
display the original text and the translation in the document in response to an insertion instruction for the translation; and
receive an edit operation on the original text, and update a translation corresponding to an edited original text based on the edited original text.

17. The computer device according to claim 16, wherein the one or more programs are executed by the one or more processors to cause the one or more processors to establish an association relationship between the original text and the translation, for enabling the translation to correspond to the original text in content.

18. A non-transitory computer-readable storage medium comprising a computer program, wherein the computer program, when executed by one or more processors, causes the one or more processors to:
generate a translation of a document in response to a translation instruction for the document, wherein the document comprises an original text;
display the original text and the translation in the document in response to an insertion instruction for the translation; and
receive an edit operation on the original text, and update a translation corresponding to an edited original text based on the edited original text.

19. The non-transitory computer-readable storage medium according to claim 18, wherein the computer program, when executed by the one or more processors, causes the one or more processors to establish an association relationship between the original text and the translation, for enabling the translation to correspond to the original text in content.

20. The non-transitory computer-readable storage medium according to claim 18, wherein the original text comprises a plurality of first parts, the translation comprises a plurality of second parts, and the plurality of second parts are associated with the plurality of first parts in a one-to-one correspondence.
